(19) United States
(12) Patent Application Publication
(10) Pub. No.: US 2025/0201917 A1
(43) Pub. Date: Jun. 19, 2025

(54) ELECTROLYTES INCLUDING OXALATE-BASED ADDITIVES FOR BATTERIES THAT CYCLE LITHIUM IONS AND BATTERIES INCLUDING THE SAME

(71) Applicant: GM GLOBAL TECHNOLOGY OPERATINS LLC, Detroit, MI (US)

(72) Inventors: Gongshin QI, Troy, MI (US); Chuanlong Wang, Troy, MI (US)

(21) Appl. No.: 18/539,576

(22) Filed: Dec. 14, 2023

(51) Int. Cl. H01M 10/0567; H01M 10/052; H01M 10/0569

(52) U.S. Cl. CPC H01M 10/0567; H01M 10/052; H01M 10/0569; H01M 2300/0034; H01M 2300/0037

(57) ABSTRACT

A battery that cycles lithium ions includes a positive electrode comprising an electroactive material comprising a lithium- and manganese-containing oxide and an electrolyte infiltrating the positive electrode. The electrolyte includes an organic solvent, a lithium salt in the organic solvent, and an oxalate-based additive in the organic solvent. The oxalate-based additive includes at least one oxalate compound selected from the group consisting of bis(2,2,2-trifluoroethyl) oxalate, tert-butyl 2,2,2-trifluoroethyl oxalate, methyl 2,2,2-trifluoroethyl oxalate, ethyl 2,2,2-trifluoroethyl oxalate, bis(2-chloroethyl) oxalate, and diethyl oxalate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to additives for electrolytes of batteries that include lithium- and manganese-containing oxides as electroactive positive electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. Layered lithium-rich and manganese-based oxides (LMR) are attractive candidates for electroactive materials of positive electrodes due to their relatively high capacity (e.g., >250 mAh/g), thermal stability, and relatively low cost. However, LMR has been found to exhibit voltage decay, low coulombic efficiency, and irreversible capacity loss after repeated charge and discharge cycles.

### SUMMARY

A battery that cycles lithium ions, in accordance with one or more embodiments of the present disclosure, comprises a positive electrode and an electrolyte infiltrating the positive electrode. The positive electrode comprises an electroactive material comprising a lithium- and manganese-containing oxide. The electrolyte comprises an organic solvent, a lithium salt in the organic solvent, and an oxalate-based additive in the organic solvent. The oxalate-based additive comprises at least one oxalate compound selected from the group consisting of bis(2,2,2-trifluoroethyl) oxalate, tert-butyl 2,2,2-trifluoroethyl oxalate, methyl 2,2,2-trifluoroethyl oxalate, ethyl 2,2,2-trifluoroethyl oxalate, bis(2-chloroethyl) oxalate, and diethyl oxalate.

The oxalate-based additive may comprise at least one fluorinated oxalate compound selected from the group consisting of bis(2,2,2-trifluoroethyl) oxalate, tert-butyl 2,2,2-trifluoroethyl oxalate, methyl 2,2,2-trifluoroethyl oxalate, and ethyl 2,2,2-trifluoroethyl oxalate.

The oxalate-based additive may constitute, by weight, greater than or equal to 0.001% and less than or equal to 10% of the electrolyte.

The oxalate-based additive may comprise bis(2,2,2-trifluoroethyl) oxalate. In such case, the bis(2,2,2-trifluoroethyl) oxalate may constitute, by weight, greater than or equal to 0.1% and less than or equal to 2% of the electrolyte.

The oxalate-based additive may further comprise at least one other compound selected from the group consisting of lithium oxalate, lithium difluorophosphate, lithium bis(oxalato) borate, lithium difluoro (oxalato) borate, lithium bis(trifluoromethanesulfonyl)imide, magnesium bis(trifluoromethanesulfonyl)imide, calcium bis(trifluoromethanesulfonyl)imide, lithium 4,5-dicyano-2-(trifluoromethyl) imidazolide, 2-methoxy-2-oxoethyl 2,2,2-trifluoroacetate, 2,2,2-trifluoroethyl acetate, ethyl 2-(2,2,2-trifluoroethoxy)acetate, ethyl 2-ethylperoxy-2-oxoacetate, 1,6-bis(sulfanyl) hexane-3,4-dione, trifluoroacetic anhydride, pentafluoropropionic anhydride, 1,1,2,2-tetrafluoroethyl-2,2,3,3-tetrafluoropropyl ether, bis(2,2,2-trifluoroethyl) carbonate, tri (2,2,2-trifluoroethyl) borate, and tris(2,2,2-trifluoroethyl) orthoformate.

The electroactive material of the positive electrode may comprise a lithium manganese-based oxide represented by the formula LiMeO₂, Li₂MeO₃, LiMe₂O₄, and/or Li₁₊ₓMe₁₋ₓO₂, where Me comprises a transition metal selected from the group consisting of Co, Ni, Mn, Fe, Al, and V, where Me comprises, by weight, greater than or equal to 50% manganese (Mn), and where 0<x≤0.33.

The lithium salt may comprise lithium hexafluorophosphate (LiPF₆).

The organic solvent may comprise a linear carbonate and a cyclic carbonate.

The organic solvent may comprise fluoroethylene carbonate (FEC) and diethyl carbonate (DEC).

A battery that cycles lithium ions, in accordance with one or more embodiments of the present disclosure, comprises a negative electrode, a positive electrode, and an electrolyte infiltrating the positive electrode. The negative electrode comprises an electroactive negative electrode material. The positive electrode comprises an electroactive positive electrode material comprising a lithium manganese-based oxide represented by the formula LiMeO₂, Li₂MeO₃, LiMe₂O₄, and/or Li₁₊ₓMe₁₋ₓO₂, where Me comprises a transition metal selected from the group consisting of Co, Ni, Mn, Fe, Al, and V, where Me comprises, by weight, greater than or equal to 50% manganese (Mn), and where 0<x≤0.33. The electrolyte comprises an organic solvent, a lithium salt in the organic solvent, and an oxalate-based additive in the organic solvent. The oxalate-based additive comprises at least one oxalate compound selected from the group consisting of bis(2,2,2-trifluoroethyl) oxalate, tert-butyl 2,2,2-trifluoroethyl oxalate, methyl 2,2,2-trifluoroethyl oxalate, ethyl 2,2,2-trifluoroethyl oxalate, bis(2-chloroethyl) oxalate, and diethyl oxalate.

The oxalate-based additive may comprise at least one fluorinated oxalate compound selected from the group consisting of bis(2,2,2-trifluoroethyl) oxalate, tert-butyl 2,2,2-trifluoroethyl oxalate, methyl 2,2,2-trifluoroethyl oxalate, and ethyl 2,2,2-trifluoroethyl oxalate.

The oxalate-based additive may constitute, by weight, greater than or equal to 0.001% and less than or equal to 10% of the electrolyte.

In aspects, the oxalate-based additive may comprise bis(2,2,2-trifluoroethyl) oxalate. In such case, the bis(2,2,2-trifluoroethyl) oxalate may constitute, by weight, greater than or equal to 0.1% and less than or equal to 2% of the electrolyte.

The oxalate-based additive may further comprise at least one other compound selected from the group consisting of lithium oxalate, lithium difluorophosphate, lithium bis(oxalato) borate, lithium difluoro (oxalato) borate, lithium bis(trifluoromethanesulfonyl)imide, magnesium bis(trifluoromethanesulfonyl)imide, calcium bis(trifluoromethanesulfonyl)imide, lithium 4,5-dicyano-2-(trifluoromethyl) imidazolide, 2-methoxy-2-oxoethyl 2,2,2-trifluoroacetate, 2,2,2-trifluoroethyl acetate, ethyl 2-(2,2,2-trifluoroethoxy)acetate, ethyl 2-ethylperoxy-2-oxoacetate, 1,6-bis(sulfanyl) hexane-3,4-dione, trifluoroacetic anhydride, pentafluoropropionic anhydride, 1,1,2,2-tetrafluoroethyl-2,2,3,3-tetrafluoropropyl ether, bis(2,2,2-trifluoroethyl) carbonate, tri (2,2,2-trifluoroethyl) borate, and tris(2,2,2-trifluoroethyl) orthoformate.

The lithium salt may comprise lithium hexafluorophosphate (LiPF₆).

The organic solvent may comprise fluoroethylene carbonate (FEC) and diethyl carbonate (DEC).

In aspects, the electroactive negative electrode material may comprise at least one of a silicon oxide-based material and a carbon-based material.

In other aspects, the electroactive negative electrode material may comprise, by weight, greater than 97% lithium.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive electrode, the porous separator, and optionally the negative electrode.

In the drawings, reference numbers may be reused to identify similar and/or identical elements.

### DETAILED DESCRIPTION

The presently disclosed electrolytes are formulated for use in batteries that cycle lithium ions and include positive electrodes comprising lithium- and manganese-containing oxides as electroactive materials. The presently disclosed electrolytes comprise an oxalate-based additive that is formulated to improve the cycle life of the batteries, for example, by helping improve the cycling stability and capacity retention of the positive electrodes.

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

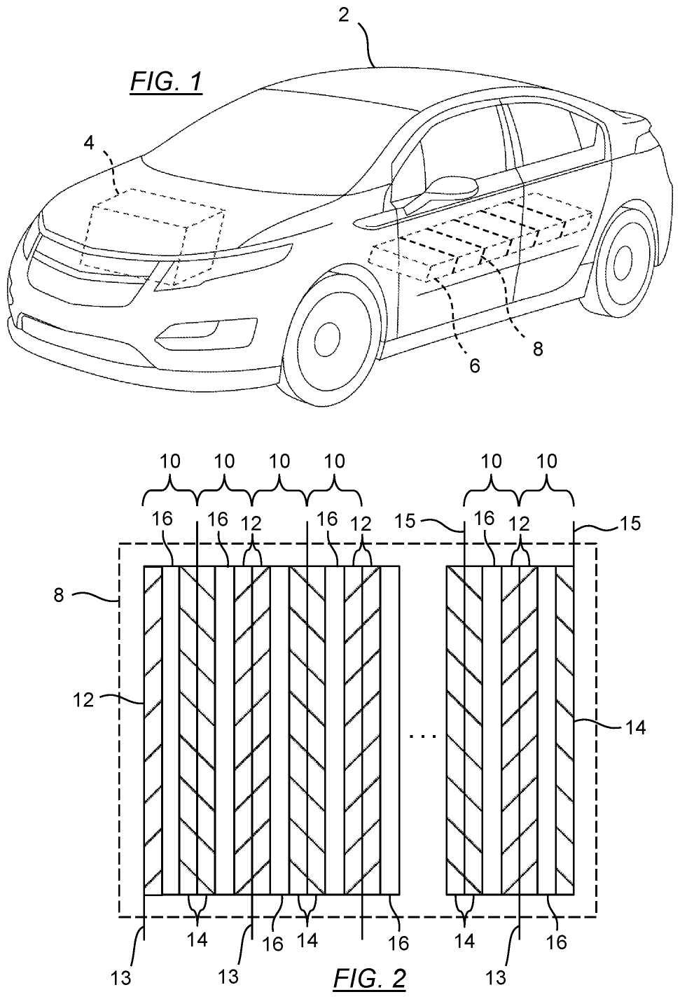

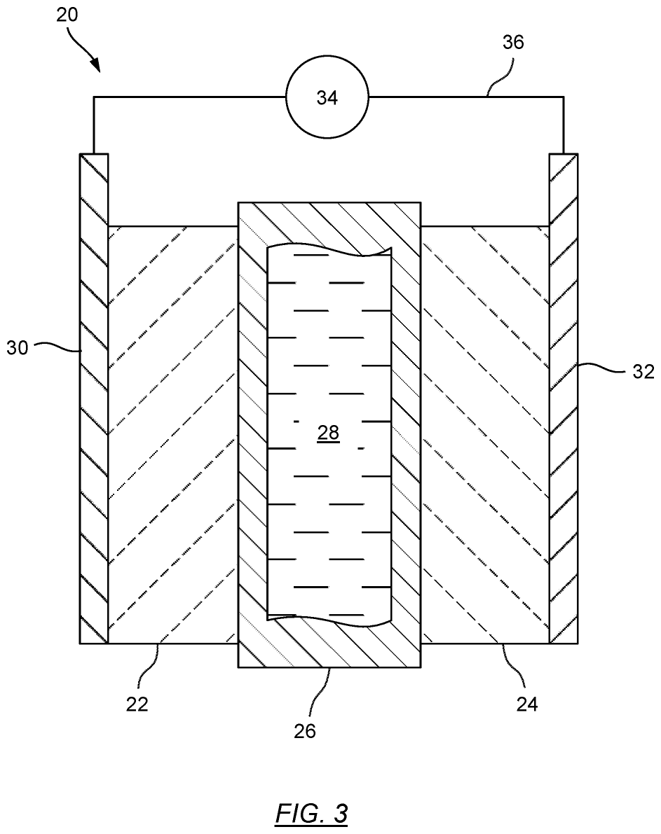

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). The electroactive material of the positive electrode 24 may constitute, by weight, greater than or equal to about 50%, optionally greater than or equal to about 60%, or optionally greater than or equal to about 70% and less than or equal to about 97%, optionally less than or equal to about 90%, or optionally less than or equal to about 80% of the positive electrode 24.

In embodiments, the electroactive material of the positive electrode 24 may comprise a lithium- and manganese-containing oxide. For example, in embodiments, the electroactive material of the positive electrode 24 may comprise a lithium manganese-based oxide represented by the formula LiMeO₂, LizMeOs (e.g., Li₂MnO₃), and/or LiMe₂O₄, where Me is a transition metal, and where Me comprises, by weight, greater than or equal to about 50% manganese (Mn). As another example, in embodiments, the electroactive material of the positive electrode 24 may comprise a layered lithium-rich manganese-based transition metal oxide represented by the formula Li₁₊ₓMe₁₋ₓO₂ (where 0<x≤0.33), where Me comprises, by weight, greater than or equal to about 50% manganese (Mn) (LMR). Other examples of lithium- and manganese-containing oxides include a spinel phase lithium manganese oxide (LiMn₂O₄, LMO), high voltage spinel phase lithium nickel manganese oxide (LiNi_{0.5}Mn_{1.5}O₄, LNMO), lithium nickel cobalt manganese aluminum oxide (NCMA), lithium nickel manganese cobalt oxide (NMC), lithium nickel manganese oxide (LNMO), e.g., LiNi_{0.5}Mn_{1.5}O₄ and/or Li_{1.2}Ni_{0.2}Mn_{0.6}O₂. Additionally or alternatively, the electroactive material of the positive electrode 24 may comprise lithium manganese iron phosphate (LMFP), lithium iron phosphate (LFP), lithium nickel cobalt aluminum oxide (NCA), or a combination thereof. In embodiments, the electroactive material of the positive electrode 24 may comprise a high voltage electroactive material formulated to operate at voltages of greater than or equal to 4.4 Volts (V), optionally greater than or equal to 4.6 V, or optionally greater than or equal to 4.8 V, and less than or equal to 5 V versus Li⁺/Li.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electroactive material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 97%, optionally less than or equal to about 90%, or optionally less than or equal to about 80% of the negative electrode 22.

In embodiments, the electroactive material of the negative electrode 22 may comprise a silicon oxide-based material (e.g., Si, SiOₓ, and/or Li_{y}SiOₓ) and a carbon-based material (e.g., graphite). In such case, the silicon oxide-based material may constitute, by weight, greater than or equal to about 10% to less than or equal to about 70%, or optionally less than or equal to about 30% of the electroactive material of the negative electrode 22 and the carbon-based material (e.g., graphite) may constitute, by weight, greater than or equal to about 30%, or optionally about 70%, to less than or equal to about 90% of the electroactive material of the negative electrode 22.

In embodiments, the negative electrode 22 may be porous and the electroactive material of the negative electrode 22 may be a particulate material. In embodiments where the electroactive material of the negative electrode 22 is a particulate material, particles of the electroactive material of the negative electrode 22 may be intermingled with a polymer binder and optionally an electrically conductive material. The same polymer binders and/or electrically conductive materials disclosed above with respect to the positive electrode 24 may be used in the negative electrode 22 in substantially the same amounts. In other embodiments, the electroactive material of the negative electrode 22 may consist of lithium and the negative electrode 22 may be in the form of a nonporous metal film or foil, such as a lithium metal film or lithium metal foil. In such case, the negative electrode 22 may comprise, by weight, greater than 97% lithium, or optionally greater than 99% lithium. In embodiments where the electroactive material of the negative electrode 22 consists of lithium, the negative electrode 22 may be substantially free of elements or compounds that undergo a reversible redox reaction with lithium during operation of the battery 20. In addition, in such embodiments, the negative electrode 22 may be substantially free of a polymer binder.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly(vinyl chloride) (PVC), and combinations thereof. In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive and provides a medium for the conduction of lithium ions between the negative electrode 22 and the positive electrode 24. The electrolyte 28 comprises an organic solvent, a lithium salt in the organic solvent, and an oxalate-based additive.

The organic solvent may comprise a nonaqueous aprotic organic solvent. Non-limiting examples of non-aqueous aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. In aspects, the organic solvent may comprise a mixture of a cyclic carbonate (e.g., FEC) and a linear carbonate (e.g., DEC). The organic solvent may constitute, by weight, greater than or equal to about 80%, or optionally greater than or equal to about 85%, and less than or equal to about 95%, or optionally less than or equal to about 90% of the electrolyte 28.

The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(fluorosulfonyl)imide (LiN(FSO₂)₂) (LIFSI), lithium tetraphenylborate (LiB(C₆H₅)₄), and combinations thereof. In aspects, the lithium salt may comprise LiPF₆. The lithium salt may be dissolved in the organic solvent at a concentration of greater than or equal to about 0.5 Molar and less than or equal to about 2 Molar. In aspects, the lithium salt may be dissolved in the organic solvent at a concentration of about 1.2 Molar. The lithium salt may constitute, by weight, greater than or equal to about 5%, optionally greater than or equal to about 10%, and less than or equal to about 20%, or optionally less than or equal to about 15% of the electrolyte 28.

The oxalate-based additive is formulated to improve the cycle life of the battery 20, for example, by helping improve the cycling stability and capacity retention of the positive electrode 24. The oxalate-based additive comprises at least one oxalate compound selected from the group consisting of bis(2,2,2-trifluoroethyl) oxalate, tert-butyl 2,2,2-trifluoroethyl oxalate, methyl 2,2,2-trifluoroethyl oxalate, ethyl 2,2,2-trifluoroethyl oxalate, bis(2-chloroethyl) oxalate, and diethyl oxalate. In embodiments, the oxalate-based additive may comprise at least one fluorinated oxalate compound selected from the group consisting of bis(2,2,2-trifluoroethyl) oxalate, tert-butyl 2,2,2-trifluoroethyl oxalate, methyl 2,2,2-trifluoroethyl oxalate, and ethyl 2,2,2-trifluoroethyl oxalate. The oxalate-based additive may constitute, by weight, greater than or equal to 0.001%, optionally greater than or equal to 0.01%, optionally greater than or equal to 0.1%, optionally greater than or equal to 0.5%, or optionally greater than or equal to 1%, and less than or equal to 10%, optionally less than or equal to 5%, or optionally less than or equal to 2%, of the electrolyte 28. In embodiments, bis(2,2,2-trifluoroethyl) oxalate may constitute, by weight, greater than or equal to 50%, optionally greater than or equal to 60%, optionally greater than or equal to 70%, optionally greater than or equal to 80%, or optionally greater than or equal to 90%, and less than or equal to 100% of the oxalate-based additive.

In addition, the oxalate-based additive optionally may comprise at least one other compound selected from the group consisting of lithium oxalate, lithium difluorophosphate (LiPO₂F₂), lithium bis(oxalato) borate (LiB(C₂O₄)₂) (LiBOB), lithium difluoro (oxalato) borate (LiBF₂(C₂O₄)) (LiDFOB), lithium bis(trifluoromethanesulfonyl)imide (LiN(CF₃SO₂)₂) (LiTFSI), magnesium bis(trifluoromethanesulfonyl)imide, calcium bis(trifluoromethanesulfonyl)imide, lithium 4,5-dicyano-2-(trifluoromethyl) imidazolide, 2-methoxy-2-oxoethyl 2,2,2-trifluoroacetate, 2,2,2-trifluoroethyl acetate, ethyl 2-(2,2,2-trifluoroethoxy)acetate, ethyl 2-ethylperoxy-2-oxoacetate, 1,6-bis(sulfanyl) hexane-3,4-dione, trifluoroacetic anhydride, pentafluoropropionic anhydride, 1,1,2,2-tetrafluoroethyl-2,2,3,3-tetrafluoropropyl ether, bis(2,2,2-trifluoroethyl) carbonate, tri (2,2,2-trifluoroethyl) borate, and tris(2,2,2-trifluoroethyl) orthoformate. When present, the at least one other compound may constitute, by weight, greater than 0%, optionally greater than or equal to 1%, optionally greater than or equal to 10%, optionally greater than or equal to 20%, or optionally greater than or equal to 30%, and less than 50% of the oxalate-based additive.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Experimental

Full coin cells including different electrolyte formulations were assembled and evaluated using galvanostatic charge and discharge protocols. All cells included a negative electrode consisting of: an electroactive material consisting of a mixture of 5.5 wt % silicon oxide, graphite, electrically conductive particles, and a polymer binder. All cells included a positive electrode consisting of: an electroactive material consisting of Li₂MnO₃, electrically conductive particles, and a polymer binder. A control electrolyte was prepared consisting of: 1.2 Molar LiPF₆ in a mixture of FEC and DEC (FEC:DEC=1:4 vol/vol). Electrolytes in accordance with embodiments of the present disclosure were prepared by adding to the control electrolyte 0.5 wt % bis(2,2,2-trifluoroethyl) oxalate (BEFEO) or 1 wt % BEFEO.

Cells including the control electrolyte, 0.5 wt % BEFEO electrolyte, or 1 wt % BEFEO electrolyte were galvanostatically charged and discharged at 25° C. During formation, the cells were charged at a C/20 rate to 4.5 V. Then, a constant current and constant voltage (CCCV) protocol was used to charge the cells at a constant current using a C/3 charge rate to a potential of about 4.4 V, then constant voltage charge at 4.4 V until the current reached C/20. The cells were subsequently discharged at a constant current using a C/3 discharge rate to 2.0 V.

Cells including the 0.5 wt % BEFEO electrolyte had higher capacity retention than cells including the control electrolyte. After about 100 cycles, cells including the 0.5 wt % BEFEO electrolyte had greater than about 97.5% capacity retention, while cells including the control electrolyte had less than about 87.5% capacity retention. After about 80 cycles, cells including the control electrolyte and cells including the 1 wt % BEFEO electrolyte had substantially similar levels of capacity retention (i.e., less than about 88%). Between cycles 1-60, the discharge capacity of the cells including the 0.5 wt % BEFEO electrolyte and the cells including the 1 wt % BEFEO electrolyte was less than that of the cells including the control electrolyte. After about 100 cycles, the discharge capacity of the cells including the 0.5 wt % BEFEO electrolyte was greater than that of the cells including the control electrolyte.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A battery that cycles lithium ions, the battery comprising:
a positive electrode comprising an electroactive material comprising a lithium- and manganese-containing oxide; and
an electrolyte infiltrating the positive electrode, the electrolyte comprising:
an organic solvent;
a lithium salt in the organic solvent; and
an oxalate-based additive in the organic solvent, the oxalate-based additive comprising at least one oxalate compound selected from the group consisting of bis(2,2,2-trifluoroethyl) oxalate, tert-butyl 2,2,2-trifluoroethyl oxalate, methyl 2,2,2-trifluoroethyl oxalate, ethyl 2,2,2-trifluoroethyl oxalate, bis(2-chloroethyl) oxalate, and diethyl oxalate.

2. The battery of claim 1, wherein the oxalate-based additive comprises at least one fluorinated oxalate compound selected from the group consisting of bis(2,2,2-trifluoroethyl) oxalate, tert-butyl 2,2,2-trifluoroethyl oxalate, methyl 2,2,2-trifluoroethyl oxalate, and ethyl 2,2,2-trifluoroethyl oxalate.

3. The battery of claim 1, wherein the oxalate-based additive constitutes, by weight, greater than or equal to 0.001% and less than or equal to 10% of the electrolyte.

4. The battery of claim 1, wherein the oxalate-based additive comprises bis(2,2,2-trifluoroethyl) oxalate.

5. The battery of claim 4, wherein the bis(2,2,2-trifluoroethyl) oxalate constitutes, by weight, greater than or equal to 0.1% and less than or equal to 2% of the electrolyte.

6. The battery of claim 1, wherein the oxalate-based additive further comprises at least one other compound selected from the group consisting of lithium oxalate, lithium difluorophosphate, lithium bis(oxalato) borate, lithium difluoro (oxalato) borate, lithium bis(trifluoromethanesulfonyl)imide, magnesium bis(trifluoromethanesulfonyl)imide, calcium bis(trifluoromethanesulfonyl)imide, lithium 4,5-dicyano-2-(trifluoromethyl) imidazolide, 2-methoxy-2-oxoethyl 2,2,2-trifluoroacetate, 2,2,2-trifluoroethyl acetate, ethyl 2-(2,2,2-trifluoroethoxy)acetate, ethyl 2-ethylperoxy-2-oxoacetate, 1,6-bis(sulfanyl) hexane-3,4-dione, trifluoroacetic anhydride, pentafluoropropionic anhydride, 1,1,2,2-tetrafluoroethyl-2,2,3,3-tetrafluoropropyl ether, bis(2,2,2-trifluoroethyl) carbonate, tri (2,2,2-trifluoroethyl) borate, and tris(2,2,2-trifluoroethyl) orthoformate.

7. The battery of claim 1, wherein the electroactive material of the positive electrode comprises a lithium manganese-based oxide represented by the formula LiMeO₂, Li₂MeO₃, LiMe₂O₄, and/or Li₁₊ₓMe₁₋ₓO₂, where Me comprises a transition metal selected from the group consisting of Co, Ni, Mn, Fe, Al, and V, where Me comprises, by weight, greater than or equal to 50% manganese (Mn), and where 0<x≤0.33.

8. The battery of claim 1, wherein the lithium salt comprises lithium hexafluorophosphate (LiPF₆).

9. The battery of claim 1, wherein the organic solvent comprises a linear carbonate and a cyclic carbonate.

10. The battery of claim 1, wherein the organic solvent comprises fluoroethylene carbonate (FEC) and diethyl carbonate (DEC).

11. A battery that cycles lithium ions, the battery comprising:
a negative electrode comprising an electroactive negative electrode material;
a positive electrode comprising an electroactive positive electrode material comprising a lithium manganese-based oxide represented by the formula LiMeO₂, Li₂MeO₃, LiMe₂O₄, and/or Li₁₊ₓMe₁₋ₓO₂, where Me comprises a transition metal selected from the group consisting of Co, Ni, Mn, Fe, Al, and V, where Me comprises, by weight, greater than or equal to 50% manganese (Mn), and where 0<x≤0.33; and
an electrolyte infiltrating the positive electrode, the electrolyte comprising:
an organic solvent;
a lithium salt in the organic solvent; and
an oxalate-based additive in the organic solvent, the oxalate-based additive comprising at least one oxalate compound selected from the group consisting of bis(2,2,2-trifluoroethyl) oxalate, tert-butyl 2,2,2-trifluoroethyl oxalate, methyl 2,2,2-trifluoroethyl oxalate, ethyl 2,2,2-trifluoroethyl oxalate, bis(2-chloroethyl) oxalate, and diethyl oxalate.

12. The battery of claim 11, wherein the oxalate-based additive comprises at least one fluorinated oxalate compound selected from the group consisting of bis(2,2,2-trifluoroethyl) oxalate, tert-butyl 2,2,2-trifluoroethyl oxalate, methyl 2,2,2-trifluoroethyl oxalate, and ethyl 2,2,2-trifluoroethyl oxalate.

13. The battery of claim 11, wherein the oxalate-based additive constitutes, by weight, greater than or equal to 0.001% and less than or equal to 10% of the electrolyte.

14. The battery of claim 11, wherein the oxalate-based additive comprises bis(2,2,2-trifluoroethyl) oxalate.

15. The battery of claim 14, wherein the bis(2,2,2-trifluoroethyl) oxalate constitutes, by weight, greater than or equal to 0.1% and less than or equal to 2% of the electrolyte.

16. The battery of claim 11, wherein the oxalate-based additive further comprises at least one other compound selected from the group consisting of lithium oxalate, lithium difluorophosphate, lithium bis(oxalato) borate, lithium difluoro (oxalato) borate, lithium bis(trifluoromethanesulfonyl)imide, magnesium bis(trifluoromethanesulfonyl)imide, calcium bis(trifluoromethanesulfonyl)imide, lithium 4,5-dicyano-2-(trifluoromethyl) imidazolide, 2-methoxy-2-oxoethyl 2,2,2-trifluoroacetate, 2,2,2-trifluoroethyl acetate, ethyl 2-(2,2,2-trifluoroethoxy)acetate, ethyl 2-ethylperoxy-2-oxoacetate, 1,6-bis(sulfanyl) hexane-3,4-dione, trifluoroacetic anhydride, pentafluoropropionic anhydride, 1,1,2,2-tetrafluoroethyl-2,2,3,3-tetrafluoropropyl ether, bis(2,2,2-trifluoroethyl) carbonate, tri (2,2,2-trifluoroethyl) borate, and tris(2,2,2-trifluoroethyl) orthoformate.

17. The battery of claim 11, wherein the lithium salt comprises lithium hexafluorophosphate (LiPF₆).

18. The battery of claim 11, wherein the organic solvent comprises fluoroethylene carbonate (FEC) and diethyl carbonate (DEC).

19. The battery of claim 11, wherein the electroactive negative electrode material comprises at least one of a silicon oxide-based material and a carbon-based material.

20. The battery of claim 11, wherein the electroactive negative electrode material comprises, by weight, greater than 97% lithium.
